(19) United States
(12) Patent Application Publication
(10) Pub. No.: US 2013/0281555 A1
(43) Pub. Date: Oct. 24, 2013

(54) PROTON EXCHANGE MATERIAL AND METHOD THEREFOR

(71) Applicants: Zhiwei Yang, Vernon, CT (US); Mallika Gummalla, Longmeadow, MA (US); Ned E. Cipollini, East Windsor, CT (US); Fuqiang Liu, Plano, TX (US); Yoichi Hosokawa, Ann Arbor, MI (US); Takumi Taniguchi, Susono (JP); Joseph S. Thrasher, Tuscaloosa, AL (US); Richard Edward Fernandez, Birmingham, AL (US); Todd S. Sayler, Tuscaloosa, AL (US); Alfred Waterfeld, Tuscaloosa, AL (US)

(72) Inventors: Zhiwei Yang, Vernon, CT (US); Mallika Gummalla, Longmeadow, MA (US); Ned E. Cipollini, East Windsor, CT (US); Fuqiang Liu, Plano, TX (US); Yoichi Hosokawa, Ann Arbor, MI (US); Takumi Taniguchi, Susono (JP); Joseph S. Thrasher, Tuscaloosa, AL (US); Richard Edward Fernandez, Birmingham, AL (US); Todd S. Sayler, Tuscaloosa, AL (US); Alfred Waterfeld, Tuscaloosa, AL (US)

(73) Assignees: Toyota Jidosha Kabushiki Kaisha, Toyota-Shi, Aichi-Ken (JP); UTC Power Corporation, South Windsor, CT (US)

(21) Appl. No.: 13/978,721

(22) PCT Filed: Jan. 11, 2011
(86) PCT No.: PCT/US11/20806

§ 371 Date: Jul. 9, 2013

(51) Int. Cl. C08F 8/30

(52) U.S. Cl. CPC C08F 8/30
USPC 521/32

(57) ABSTRACT

A proton exchange material includes perfluorinated carbon backbone chains and side chains extending off of the perfluorinated carbon backbone chains. The perfluorinated side chains include cross-link chains that have multiple sulfonimide groups, —SO₂—NH—SO₂—.

### BACKGROUND

This disclosure relates to fluoropolymers that are used as proton exchange materials in applications such as fuel cells.

Fuel cells are commonly used for generating electric current. A single fuel cell typically includes an anode catalyst, a cathode catalyst, and an electrolyte between the anode and cathode catalyst for generating an electric current in a known electrochemical reaction between a fuel and an oxidant. The electrolyte may be a fluoropolymer membrane, which is also known as a proton exchange membrane or “PEM.”

One common type of fluoropolymer membrane is sulfonated tetrafluoroethylene, known as NAFION. Sulfonated tetrafluoroethylene includes proton exchange sites that function to transmit protons between the anode and cathode catalyst. The proton exchange site is at a sulfonic acid group SO₃H, which terminates a pendent perfluorinated side chain of the polymer. Another common type of fluoropolymer membrane is sulfonamide which also includes proton exchange sites that function to transmit protons between the anode and cathode catalyst. The proton exchange site is at a nitrogen atom —SO2—NH—SO2—CF3 which terminates a pendent side chain of the polymer.

### SUMMARY

A disclosed proton exchange material includes perfluorinated carbon backbone chains and side chains extending off of the perfluorinated carbon backbone chains. The side chains include cross-link chains that have multiple sulfonimide groups, —SO₂—NH—SO₂—.

An example method of fabricating a proton exchange material includes forming a polymer having perfluorinated carbon backbone chains and perfluorinated side chains extending off of the perfluorinated carbon backbone chains. The perfluorinated side chains include cross-link chains that have multiple sulfonimide groups, —SO₂—NH—SO₂—.

### DETAILED DESCRIPTION OF THE PREFERRED EMBODIMENT

The disclosed example proton exchange materials may be used for fuel cell proton exchange membranes or other applications where proton exchange is desirable. As will be described, the disclosed proton exchange material provides the ability to increase the number of proton exchange sites on a molar basis while maintaining resistance to solvents, such as water. As a comparison, an increase in the number of proton exchange sites in sulfonated tetrafluoroethylene increases proton conductivity but also increases solubility in water, which is detrimental in fuel cell applications. Conversely, a decrease in the number of proton exchange sites in sulfonated tetrafluoroethylene provides an increase in resistance to water but decreases proton conductivity and debits fuel cell performance.

An example proton exchange material includes perfluorinated carbon backbone chains and perfluorinated side chains extending off of the perfluorinated carbon backbone chains. The perfluorinated side chains include cross-link chains that have multiple sulfonimide groups, —SO₂—NH—SO₂—.

In embodiments, the perfluorinated carbon backbone chains have a structure of —(CF₂)—. The perfluorinated side chains include a general structure of —C_{X}F_{2X}O_{Z}—, where X is greater than or equal to two and Z is greater than or equal to zero. For instance, the side chains have a structure —{(CF₂)_{q1}—(SI)—(CF₂)_{q2}Oₜ}ᵣ, where SI is the sulfonimide group, q1 and q2 are greater than or equal to one and t is greater than or equal to zero.

In embodiments, the side chains that extend off of the backbone chains may be end-capped chains, cross-link chains, or both. The end-capped chains may have at least one sulfonimide group, —SO₂—NH—SO₂— and may include between two and five of the sulfonimide groups or even greater than five sulfonimide groups. Additionally, the end-capped chains may be capped with a CF₃ group a SO₃H group, or a portion of the side chains may be capped with CF₃ groups and another portion with SO₃H groups. The end-capped chains that are capped with CF₃ may include multiple sulfonimide groups and the portion of end-capped chains that are capped with SO₃H may include at least one sulfonimide group.

In the proton exchange material, 20-99% of the perfluorinated side chains may be the end-capped chains and 1-80% of the side chains may be the cross-link chains. In other examples, 50-99% of the perfluorinated side chains are the end-capped chains and 1-50% of the side chains are the cross-link chains.

In one example, the proton exchange material has Structure 1 shown below, where the horizontal lines represent the perfluorinated carbon backbone chains, the vertical lines represent side chains, SI is sulfonimide, m is greater than or equal to one, n is greater than or equal to two, and p is greater than or equal to two. The amounts of side chains and cross-link chains may be as described above.

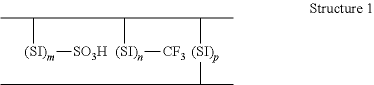

In another example, the proton exchange material has Structure 2 shown below, where the horizontal lines represent the perfluorinated carbon backbone chains, the vertical lines represent side chains, SI is sulfonimide, m is greater than or equal to 1, n is greater than or equal to two, and p is greater than or equal to two. The amounts of side chains and cross-link chains may be as described above.

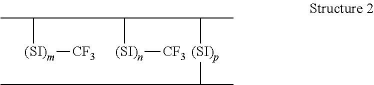

In other embodiments, the proton exchange material includes perfluorinated carbon chains and proton exchange sites that are located exclusively on perfluorinated cross-links that include at least one sulfonimide group (“SI”), —SO₂—NH—SO₂—, where the nitrogen in the sulfonimide group is a type of proton exchange site. That is, the nitrogen atom or atoms of the sulfonimide group or groups are the only proton exchange sites within the proton exchange material. For instance, the proton exchange material has Structure 3 shown below, where the backbones and cross-links are perfluorinated carbon chains and m is greater than or equal to two.

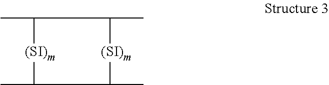

In a further example, the cross-links have the sulfonimide structure (SO₂NHSO₂ (CF₂)ₙ)_{m,} where 1<n<1000 and m is greater than or equal to two.

A user may design the proton exchange material of the disclosed examples with a selected number of sulfonimide groups within the side chains to provide a desired equivalent weight (1/mol %) of proton exchange sites (nitrogen atoms).

The location of the sulfonimide group or groups on cross-link chains of the proton exchange material also provides the ability to design the material with a particular equivalent weight for high proton conductivity and high resistance to solvents, such as water. For instance, the cross-linking of the perfluorinated carbon chains resists “washing out” of the sulfonimide group or groups and thereby provides resistance to water and swelling. In some examples, the proton exchange material has an ionic exchange capacity of more than two times that of sulfonated tetrafluoroethylene (Nafion).

The equivalent weight of the proton exchange material may be 700-1,000. The disclosed range provides relatively high proton conductivity and a suitable rheology for membranes or other shapes that are desired for a fuel cell or other applications. Moreover, the sulfonimide group is a stronger acid than sulfonic acid. In a further example, the equivalent weight is 850-950. As a comparison, a similar polymer with an equivalent weight below approximately 560 is a semi-solid, low molecular weight material that would not be mechanically suitable as a membrane. Sulfonated tetrafluoroethylene with an equivalent weight of above approximately 1100 is a tough, solid material that has a low solubility in water or other polar solvents.

A user may fabricate the disclosed proton exchange material by forming a polymer having perfluorinated carbon backbone chains and perfluorinated side chains extending off of the perfluorinated carbon backbone chains, where the perfluorinated side chains include cross-link chains that have multiple sulfonimide groups, —SO₂—NH—SO₂—. As an example, the forming includes synthesizing a perfluorinated sulfonic acid precursor and converting sulfonic acid groups, —SO₂F, in the perfluorinated sulfonic acid precursor to amide groups, —SO₂NH₂. The user then converts the amide groups, —SO₂NH₂, to the sulfonimide groups, —SO₂—NH—SO₂—. Depending on the desired structure of the proton exchange material, the conversions of the amide groups to sulfonimide groups are conducted using an end-capping agent, a cross-linking agent, or both.

In other examples, the forming includes synthesizing a perfluorinated sulfonic acid precursor, synthesizing a linear sulfonimide precursor, and cross-linking the sulfonimide precursor with the perfluorinated sulfonic acid precursor to produce the disclosed proton exchange material (target material). An example of a synthesis process is shown below in Steps 1-3.

Step 1.

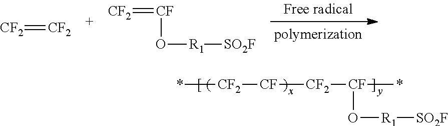

Step 2.

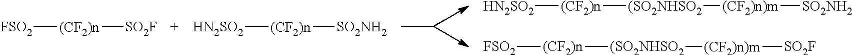

Step 3.

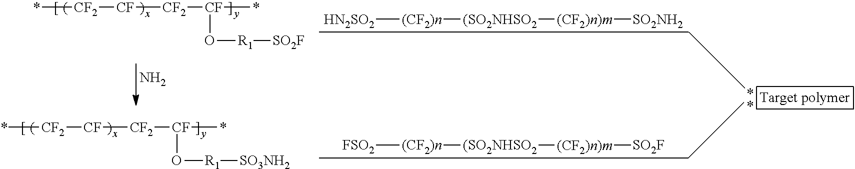

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A proton exchange material comprising:
perfluorinated carbon backbone chains; and
side chains extending off of the perfluorinated carbon backbone chains, the side chains including cross-link chains that have multiple sulfonimide groups, —SO₂—NH—SO₂—.

2. The proton exchange material as recited in claim 1, wherein the side chains include end-capped chains that have at least one sulfonimide group, —SO₂—NH—SO₂—.

3. The proton exchange material as recited in claim 2, wherein the end-capped chains include between two and five sulfonimide groups.

4. The proton exchange material as recited in claim 2, wherein 20-99% of the side chains are the end-capped chains and 1-80% of the side chains are the cross-link chains.

5. The proton exchange material as recited in claim 2, wherein 50-99% of the side chains are the end-capped chains and 1-50% of the side chains are the cross-link chains.

6. The proton exchange material as recited in claim 2, wherein a portion of the end-capped chains are capped with CF₃ and another portion of the end-capped chains are capped with SO₃H.

7. The proton exchange material as recited in claim 6, wherein the end-capped chains that are capped with CF₃ include multiple sulfonimide groups and the portion of end-capped chains that are capped with SO₃H include at least one sulfonimide group.

8. The proton exchange material as recited in claim 2, wherein the end-capped chains are capped with CF₃.

9. The proton exchange material as recited in claim 2, wherein the end-capped chains are capped with SO₃H.

10. The proton exchange material as recited in claim 1, wherein the side chains include between two and five sulfonimide groups.

11. The proton exchange material as recited in claim 1, wherein any proton exchange sites are located exclusively on the cross-link chains.

12. The proton exchange material as recited in claim 1, comprising an equivalent weight (1/mol %) of 700-1,000 with regard to the proton exchange sites.

13. The proton exchange material as recited in claim 12, wherein the equivalent weight is 850-950.

14. A method of fabricating a proton exchange material, comprising:
forming a polymer having perfluorinated carbon backbone chains and perfluorinated side chains extending off of the perfluorinated carbon backbone chains, the side chains including cross-link chains that have multiple sulfonimide groups, —SO₂—NH—SO₂—.

15. The method as recited in claim 14, wherein the forming includes synthesizing a perfluorinated sulfonic acid precursor and converting sulfonic acid groups, —SO₂F, in the perfluorinated sulfonic acid precursor to amide groups, —SO₂NH₂.

16. The method as recited in claim 15, wherein the forming includes converting the amide groups, —SO₂NH₂, to the sulfonimide groups, —SO₂—NH—SO₂—.

17. The method as recited in claim 14, wherein the forming of the polymer includes synthesizing a perfluorinated sulfonic acid precursor, synthesizing a linear sulfonimide precursor, and cross-linking the perfluorsulfinated sulfonic acid precursor with the sulfonimide precursor to produce the polymer.
